(19) United States
(12) Patent Application Publication
(10) Pub. No.: US 2024/0183521 A1
(43) Pub. Date: Jun. 6, 2024

(54) Splicing Piece and Lighting Apparatus

(71) Applicant: APUTURE IMAGING INDUSTRIES CO., LTD., Shenzhen (CN)

(72) Inventors: Weisong Zhang, Shenzhen (CN); Chongbo Huang, Shenzhen (CN); Daoyou Peng, Shenzhen (CN)

(21) Appl. No.: 18/525,891

(22) Filed: Dec. 1, 2023

(30) Foreign Application Priority Data
Dec. 2, 2022 (CN) 202223242069.4

(51) Int. Cl. F21V 23/06; F21S 4/28

(52) U.S. Cl. CPC F21V 23/06; F21S 4/28

(57) ABSTRACT

Disclosed in the present disclosure is a splicing piece, including: a base, the base provided with a central area and including at least two connecting parts, in which the connecting part is centrosymmetrically provided around the central area and includes at least one splicing area; an electrical connector, the electrical connector provided on each splicing area; a fixing connector, the fixing connector provided beside the electrical connector on the splicing area; and at least one wiring groove, the wiring groove provided to avoid the fixing connector and used for being in communication with the adjacent electrical connectors on the splicing area. In the present disclosure, the electrical connector is provided on the splicing piece to avoid direct connection between the lighting bars, and the wiring groove is provided on the splicing piece, improving aesthetics and safety.

### CROSS-REFERENCE TO RELATED APPLICATIONS

The present application claims priority of Chinese Patent Application No. 202223242069.4 filed on Dec. 2, 2022 before CNIPA. All the above are hereby incorporated by reference in their entirety.

### FIELD

The present disclosure relates to the field of lighting apparatuses, in particular to a splicing piece and a lighting apparatus.

### BACKGROUND

At present, during content creation relating to film and television, advertising, and video, it may relate to light distribution for shooting objects or scenes. With various shooting scenes and objects, it is usually not enough to satisfy shooting requirements with merely one apparatus. However, a large photographic light is bulky and heavy, and the brightness of a single photographic light is not enough to satisfy shooting requirements. Therefore, it is often necessary to build combinations of a number of lights, which are required to be spliced into patterns that are more regular or representative to be used as an effect and to render an ambiance. As a result, it is sometimes necessary to splice a plurality of lighting devices together to facilitate a desired light distribution.

However, a connector on the market commonly adopts a bolt-type connector. When splicing two or more lighting devices, it is easy to produce the problem of unstable electrical connections between lighting devices due to unstable connections at connection positions. In the prior art, in order to solve the problem thereof, it is generally adopted a method of separating wires and splicing pieces. Two wires are adopted to directly connect between lighting devices, avoiding the problem of an abnormal electrical connection caused by mechanical connection problems. However, when there are too many lighting devices on a splicing piece, there are too many wires connected electrically, which causes unsightly problems. Uncovered and cluttered wires may also cause safety issues as they age or break.

### SUMMARY

The technical solutions adopted in the present disclosure to solve the problems mentioned above are as follows.

A splicing piece includes: a base, the base provided with a central area, and including at least two connecting parts, in which the connecting part is centrosymmetrically provided around the central area and includes at least one splicing area; an electrical connector, the electrical connector provided on each splicing area; a fixing connector, the fixing connector provided beside the electrical connector on the splicing area; and at least one wiring groove, the wiring groove provided to avoid the fixing connector and used for being in communication with the adjacent electrical connectors on the splicing area.

By adopting the solution mentioned above, the electrical connector is provided on the splicing piece to avoid direct connection between the lighting bars; the wiring groove is provided on the splicing piece, so as to electrically connect two lights by allowing wires to pass through the wiring groove; and two or more fixing connectors are provided around the electrical connector, which effectively improves the stability of the connection at a position with the electrical connector.

Further, at least two connecting parts of the base are non-coplanar; each two of the connecting parts are centrosymmetrically provided around the central area; and an included angle between the two connecting parts that are non-coplanar is 60°-150°.

By adopting the solution mentioned above, it may be used to direct a lighting surface of the two non-coplanar lighting bars onto a same object positioned between two lighting apparatuses, achieving the light distribution of both sides of the object, such as a human face, and avoiding the problem of shadows on the face caused by the light positioned on a single side of the face.

Further, the base includes two connecting parts; the connecting part is provided with merely one splicing area; each splicing area is provided with one electrical connector and at least two fixing connectors; and the fixing connector is arranged on a periphery taking the electrical connector as a center.

By adopting the solution mentioned above, it achieves the electrical connection and mechanical fixation between the two non-coplanar lighting bars.

Further, each of the connecting parts of the base is coplanar with each other; each splicing area is provided with one electrical connector and at least two fixing connectors; and distances between each splicing area and the central area are identical.

By adopting the solution mentioned above, it may achieve a spotlight effect when illuminating the same side, also allowing the presence of an angle between two lighting apparatuses, which facilitates installation or application in special structures.

Further, the base includes two connecting parts; both connecting parts are provided with merely one splicing area; the splicing area is provided with one electrical connector and at least two fixing connectors; a connecting line between one of the electrical connectors and the central area is collinear to a connecting line between the other of the electrical connectors and the central area; and both of the fixing connectors are positioned on a straight line between the electrical connector and the central area.

By adopting the solution mentioned above, it allows the structures on the base to be arranged in a linear pattern. The base may be collinear or perpendicular to the lighting bar when splicing with the lighting bar, which increases the splicing manners between the base and the lighting bar, which includes, but is not limited to, splicing two lighting bars in series or in parallel.

Further, the base includes a plurality of connecting parts; all of the connecting part is provided with merely one splicing area; the splicing area is provided with one electrical connector and three fixing connectors; and each two included angles are identical, in which the included angle is between a line of any one of the electrical connectors to the central area and a line of the adjacent electrical connector to the central area.

By adopting the solution mentioned above, it may achieve a radial splicing structure with a plurality of lighting bars taking the splicing piece as a center, and each two included angles are identical, in which the included angle is between two adjacent lighting bars, which further improves a spotlight effect when illuminating the same side.

Further, the base includes two connecting parts which are a first connecting part and a second connecting part respectively; both the first connecting part and the second connecting part are provided with merely one splicing area; the splicing area is provided with one electrical connector and three fixing connectors; and an included angle between a line of the first connecting part to the central area and a line of the second connecting part to the central area is 30°-150°.

By adopting the solution mentioned above, it may achieve the splicing of two coplanar lighting bars and allows the presence of an angle between the two lighting bars after splicing.

Further, the splicing piece includes a cover plate; and the cover plate is provided on a surface where the wiring groove of the base is positioned, and used to cover the wiring groove.

By adopting the solution mentioned above, the wiring groove may be concealed by providing a cover plate, and covering the lines serves to protect the lines. The disassembled fixing connector may be restricted to the base to reduce the problem of missing the fixing connector after disassembled.

Further, the splicing piece includes a positioning part; a surface of each connecting part distal to the central area is set as an end surface; and the positioning part is provided on the end surface of the connecting part positioned in each splicing area.

By adopting the solution mentioned above, by providing the positioning part, it improves the efficiency of assembly, which restricts a facing direction and an angle of the lighting apparatus, and simplifies the mounting steps and difficulties.

A lighting apparatus includes at least two lighting bar and one splicing piece; and the lighting bar includes at least one mounting part for connecting to the splicing area of the base.

By adopting the solution mentioned above, it achieves the splicing effect between the lighting bars, and the connection is stable, which facilitates disassembly. Additionally, it may achieve a light distribution or a spotlight effect with a specific role.

### BRIEF DESCRIPTION OF THE DRAWINGS

FIG. 1 is a structural diagram of the splicing piece in the embodiment 1 of the present disclosure;

FIG. 2 is a structural diagram in an exploded view of the splicing piece in the embodiment 1 of the present disclosure;

FIG. 3 is a structural diagram of the splicing piece in the embodiment 1 of the present disclosure;

FIG. 4 is a structural diagram in an exploded view of the splicing piece in the embodiment 1 of the present disclosure;

FIG. 5 is a structural diagram of the splicing piece in the embodiment 2 of the present disclosure;

FIG. 6 is a structural diagram in an exploded view of the splicing piece in the embodiment 2 of the present disclosure;

FIG. 7 is a structural diagram of the splicing piece in the embodiment 2 of the present disclosure;

FIG. 8 is a structural diagram in an exploded view of the splicing piece in the embodiment 2 of the present disclosure;

FIG. 9 is a structural diagram of the splicing piece in the embodiment 3 of the present disclosure;

FIG. 10 is a structural diagram in an exploded view of the splicing piece in the embodiment 3 of the present disclosure;

FIG. 11 is a structural diagram of the splicing piece in the embodiment 4 of the present disclosure;

FIG. 12 is a structural diagram in an exploded view of the splicing piece in the embodiment 4 of the present disclosure;

FIG. 13 is a structural diagram of the embodiment 1 in the present disclosure.

The meanings of the attached markings are as follows: 1 base; 11 connecting part; 111 central area; 12 first connecting part; 13 second connecting part; 14 splicing area; 141 fixing insertion hole; 142 electrical insertion slot; 15 fixing hole; 2 electrical connector; 3 fixing connector; 31 fixing end; 32 driving end; 321 driving groove; 33 restricting piece; 34 annual groove; 4 cover plate; 41 fixing perforation; 42 shielding plate; 5 wiring groove; 6 positioning part; 7 guiding groove.

### DETAILED DESCRIPTION OF THE PREFERRED EMBODIMENTS

For a better understanding and implementation, the technical solutions in the embodiments of the present disclosure are clearly and completely described and discussed below in conjunction with the attached drawings of the present disclosure. Obviously, the embodiments described herein are only some of the embodiments of the present disclosure but not all of them. Based on the embodiments in the present disclosure, all other embodiments acquired by those skilled in the art without inventive effort fall within the scope of protection of the present disclosure.

In order to facilitate the understanding of the embodiments of the present disclosure, specific embodiments in conjunction with the attached drawings are further explained hereinafter, and each embodiment does not constitute a limitation to the embodiments of the present disclosure.

In the description of the present disclosure, it is to be noted that the terms “up”, “down”, “front”, “back”, “left”, “right”, “vertical”, “horizontal”, “top”, “bottom”, “inside”, “outside” and other orientation or position relationships are based on the orientation or position relationships shown in the attached drawings. It is only intended to facilitate description of the present disclosure and simplify description, but not to indicate or imply that the referred device or element has a specific orientation, or is constructed and operated in a specific orientation. Therefore, they should not be construed as a limitation of the present disclosure.

Unless otherwise defined, all terms including technical and scientific terms used herein have the same meaning as commonly understood by those skilled in the art to which the present disclosure belongs. The terms used herein in the specification of the present disclosure are used only to describe specific embodiments and are not intended as a limitation of the application.

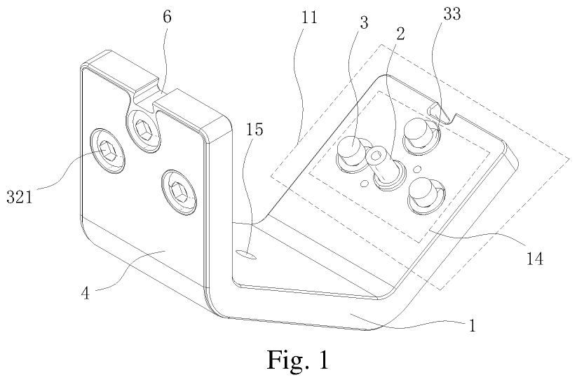

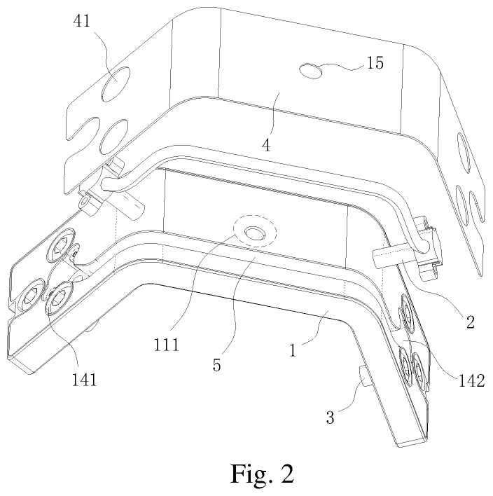

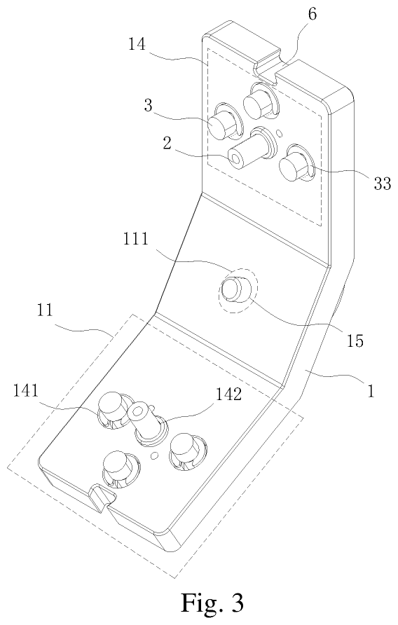

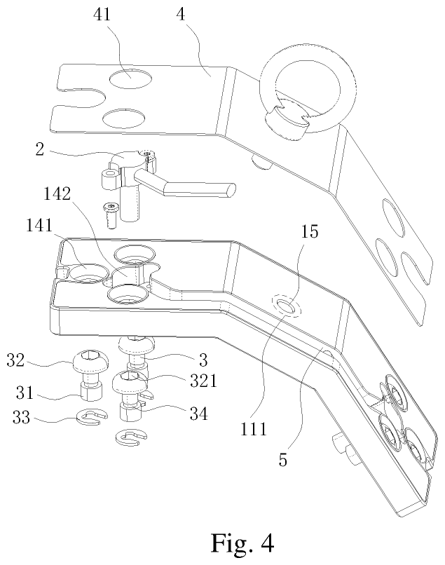

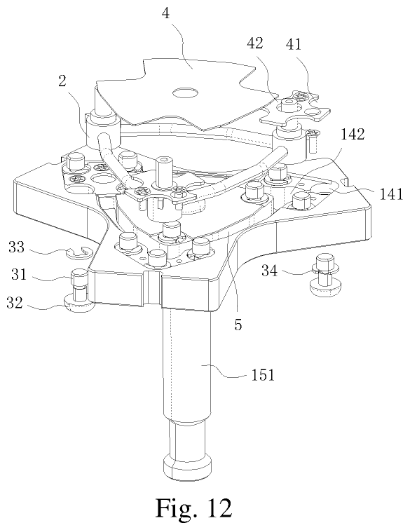

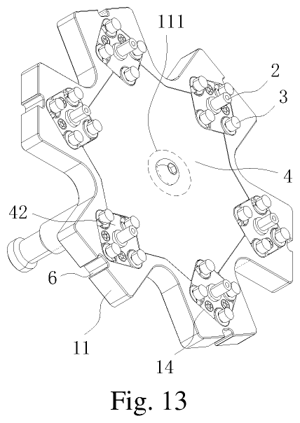

Referring to FIGS. 1-13, disclosed in the present disclosure is a splicing piece, including a base 1, an electrical connector 2, a fixing connector 3 and a wiring groove; the base 1 is provided with a central area 111 which may be understood as a point, or relatively understood as a symmetry line, or certainly as a piece of area where a center of the base 1 is positioned; the base 1 includes at least two connecting parts 11; the connecting part 11 is centrosymmetrically provided around the central area 111 and includes at least one splicing area 14; the electrical connector 2 is provided on each splicing area 14; the fixing connector 3 is provided beside the electrical connector 2 on the splicing area 14; and the wiring groove 5 is provided to avoid the fixing connector 3 and used for being in communication with the adjacent electrical connectors 2 on the splicing area. The present disclosure is introduced in detail by the embodiments as follows.

Referring to FIGS. 1-4, disclosed in the embodiment 1 of the present disclosure is a splicing piece. The base 1 includes two connecting parts 11 positioned in two ends of the base 1 respectively, there are two end surface positioned in the base 1; the two connecting parts 11 are non-coplanar with each other; there is a central area 111 between the two connecting parts 11, causing distances between each non-coplanar connecting part 11 and the central area 111 are identical; and an included angle between the two connecting parts 11 that are non-coplanar is 60°-150° and is preferably 60° and 120°. Specifically, the connecting part 11 is provided with one splicing area 14; the splicing area 14 is provided with one electrical connector 2 and three fixing connectors 3; one of the fixing connectors 3 is positioned on a side of the electrical connector 2 proximal to the end surface of the base 1; and the other two fixing connectors 3 is provided on a straight line passing through the electrical connector 2 and parallel to the end surface of the base 1. Admittedly, in other embodiments, the fixing connector 3 may be arranged on a periphery taking the electrical connector as a center, and a number thereof is not limited, which may be modified in accordance with actual situations.

In the present embodiment 1, the two end surfaces of the base 1 is further provided a positioning part 6; the positioning part 6 is a groove concaved with respect to the end surface; and a direction of the groove is identical to an axial direction of the fixing connector 3 for playing a positioning role when splicing the splicing area 14 of the splicing piece to a lighting bar, improving the installation efficiency and reducing the possibility of incorrect installation. Admittedly, in other embodiments, a structure of the positioning part 6 may be a structure protruding from the end surface, or other structures that may be positioned with the lighting bar, which is not specifically limited in the present embodiment.

In the present embodiment 1, a fixing hole 15 is further provided in a central area 111 positioned between the two connecting parts 11. The base 1 is connected or fixed to a designated position by connecting a fixing rod or other supporting members on the fixing hole 15 to achieve the fixation of the lighting bars by fixing the splicing pieces. Admittedly, the fixing hole 15 may also not be round in shape, which is not specifically limited in the present embodiment.

In the present embodiment 1, there are two surfaces on the base 1 perpendicular to the fixing connector 3, and the wiring groove 5 is provided in any one of the two surfaces and connected between the two electrical connectors 2 with avoiding the fixing connector 3. There is a cover plate 4 mounted on a side of the wiring groove 5 and fixed to the base 1 by screws. Admittedly, the fixing manner between the cover plate 4 and the base 1 may further be other fixing manners besides screws, which is not specifically limited in the present embodiment.

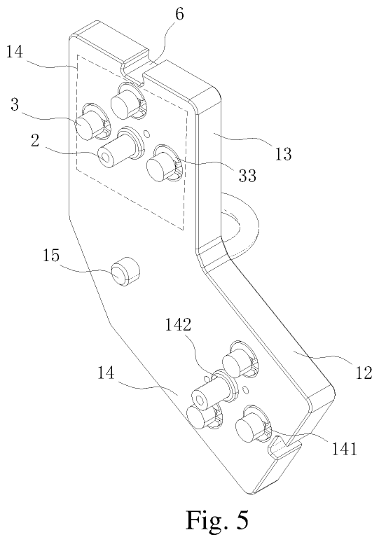

Referring to FIGS. 5-8, disclosed in the embodiment 2 of the present disclosure is a splicing piece. The base 1 included two connecting parts 11 that are coplanar with each other, and the two connecting parts 11 are a first connecting part 12 and a second connecting part 13 respectively. There is a central area 111 on the base 1, causing a distance between the first connecting part 12 and the central area 111 to identical with a distance between the second connecting part 13 and the central area 111. An included angle between a line of the first connecting part 12 to the central area 111 and a line of the second connecting part 13 to the central area 111 is 30°-150° and is preferably 60° and 120°. Specifically, both of the first connecting part 12 and the second connecting part 13 are provided with merely one splicing area 14. Two surfaces of the base 1 being perpendicular to a connecting line between the electrical connectors 2 and the central area 111 are set as an end surface. The splicing area 14 is provided with one electrical connector 2 and three fixing connectors 3; one of the fixing connectors 3 is positioned on a side of the electrical connector 2 proximal to the end surface of the base 1; and the other two fixing connectors 3 are provided on a straight line passing through the electrical connector 2 and parallel to the end surface of the base 1. Admittedly, in other embodiments, the fixing connector 3 may be arranged on any periphery position taking the electrical connector as a center, and a number thereof is not limited, which may be modified in accordance with actual situations.

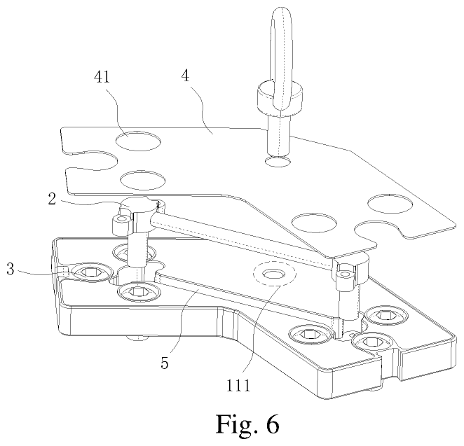

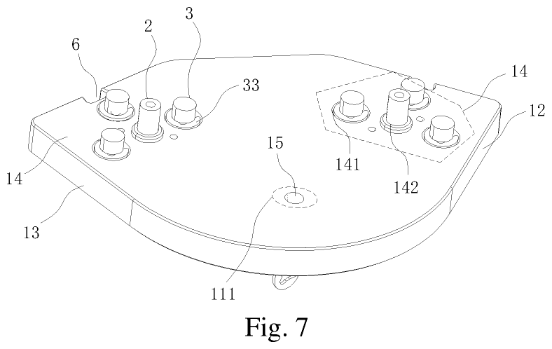

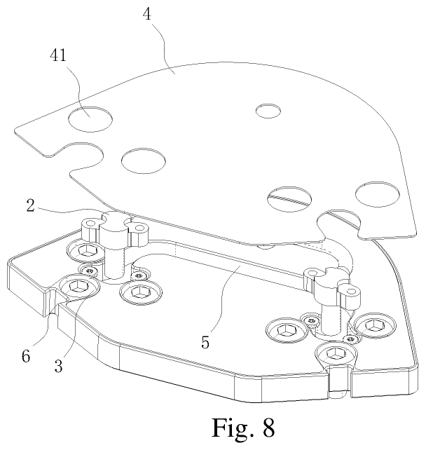

Referring to FIGS. 5-6, disclosed in the present embodiment 2, there may be a bending part provided between the first connecting part 12 and the second connecting part 13 of the base 1. Referring to FIGS. 7-8, the base 1 may also connect the first connecting part 12 with the second connecting part 13 without spacing between them, forming a base 1 contour of any symmetrical structure without interfering with the normal splicing of the lighting bars.

In the present embodiment 2, each of the two end surfaces of the base 1 is further provided a positioning part 6; the positioning part 6 is a groove concaved with respect to the end surface; and a direction of the groove is identical to an axial direction of the fixing connector 3 for playing a positioning role when splicing the splicing area 14 of the splicing piece to a lighting bar, improving the installation efficiency and reducing the possibility of incorrect installation. Admittedly, in other embodiments, a structure of the positioning part 6 may protrude from the end surface, or other structures that may be positioned with the lighting bar, which is not specifically limited in the present embodiment.

In the present embodiment 2, a fixing hole 15 is further provided in a central area 111 positioned between the two connecting parts 11. The base 1 is connected or fixed to a designated position by connecting a fixing rod or other supporting members on the fixing hole 15 to achieve the fixation of the lighting bars by fixing the splicing pieces. Admittedly, the fixing hole 15 may also not be round in shape, which is not specifically limited in the present embodiment.

In the present embodiment 2, there are two surfaces on the base 1 perpendicular to the fixing connector 3, and the wiring groove 5 is provided in any one of the two surfaces to avoid the fixing connector 3 and used for connecting between the two electrical connectors 2. There is a cover plate 4 mounted on a side of the wiring groove 5 and fixed to the base 1 by screws. Admittedly, the fixing manner between the cover plate 4 and the base 1 may further be other fixing manners besides screws, which is not specifically limited in the present embodiment.

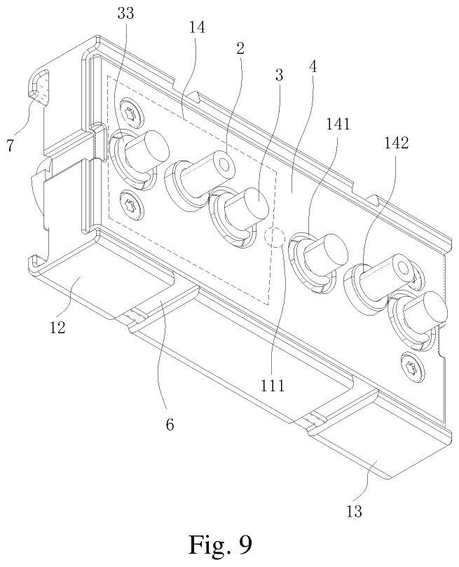

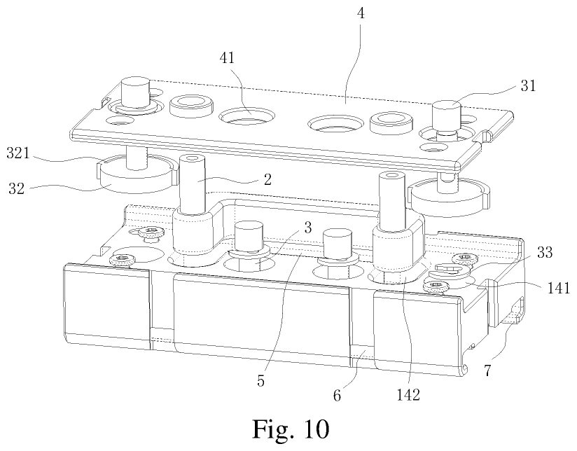

Referring to FIGS. 9-10, disclosed in the embodiment 3 of the present disclosure is a splicing piece. The base 1 includes two coplanar connecting parts 11 positioned in two ends of the base 1 respectively. There is a central area 111 between the two connecting parts 11, causing distances between each connecting part 11 and the central area 111 to be identical. And the two connecting parts 11 and the central area 111 are all positioned in a collinear line. Specifically, both of the two connecting parts 11 are merely provided with one splicing area 14; the splicing area 14 is provided with one electrical connector 2 and at least two fixing connectors 3; a connecting line between one of the electrical connectors 2 and the central area 111 is collinear to a connecting line between the other of the electrical connectors 2 and the central area 111; and both of the fixing connectors 3 are positioned on a straight line between the electrical connector 2 and the central area 111. Admittedly, in other embodiments, the fixing connector 3 may be arranged on any periphery position taking the electrical connector 2 as a center, and a number thereof may not be two and may be modified in accordance with the actual situations. In the present embodiment 3, due to a linear structure of the base 1, causing the electrical connector 2 and the fixing connector 3 on the base are arranged in a linear shape. The base 1 may be collinear or perpendicular to the lighting bar when splicing with the lighting bar, which increases the splicing manners between the base 1 and the lighting bar, which includes, but is not limited to, splicing two lighting bars in series or in parallel.

In the present embodiment 3, four surfaces of the base 1 parallel an axial direction of the fixing connector 3 is provided a plurality of positioning parts 6, with each positioning part 6 spaced apart from the others thereof; the positioning part 6 is a groove concaved with respect to the end surface; and a direction of the groove is identical to an axial direction of the fixing connector 3 for playing a positioning role when splicing the splicing area 14 of the splicing piece to the lighting bar, improving the installation efficiency and reducing the possibility of incorrect installation. Admittedly, in other embodiments, a structure of the positioning part 6 may protrude from the end surface, or other structures that may be positioned with the lighting bar, which is not specifically limited in the present embodiment.

In the present embodiment 3, there are two surfaces on the base 1 perpendicular to the fixing connector 3, and the wiring groove 5 is provided in any one of the two surfaces and connected between the two electrical connectors 2 with avoiding the fixing connector 3. There is a cover plate 4 mounted on a side of the wiring groove 5 and fixed to the base 1 by screws. Admittedly, the fixing manner between the cover plate 4 and the base 1 may further be other fixing manners besides screws, which is not specifically limited in the present embodiment.

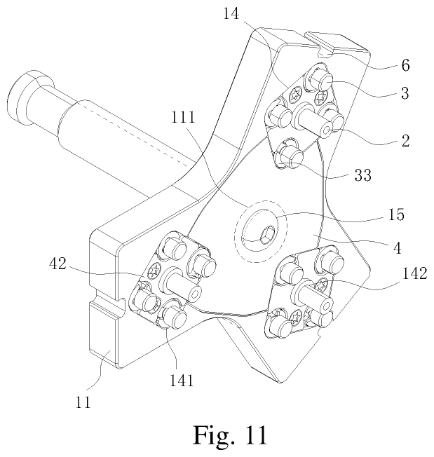

Referring to FIGS. 11-13, disclosed in the embodiment 4 of the present disclosure is a splicing piece; the base 1 includes a plurality of coplanar connecting parts 11. There is a central area 111 among the plurality of connecting parts 11, causing distances between each connecting part 11 and the central area 111 to be identical, and causing the connecting part 11 to be arranged on a periphery taking the electrical connector 2 as a center. Specifically, all of the connecting part 11 is merely provided with one splicing area 14; the splicing area 14 is provided with one electrical connector 2 and three fixing connectors 3; and each two adjacent included angles are identical, in which the included angle is between a line of any one of electrical connector 2 to the central area 111 and a line of the adjacent electrical connector 2 to the central area 111. A surface of the base 1 perpendicular to a connecting line between the electrical connectors 2 and the central area 111 are set as an end surface. In each splicing area 14, one of the three fixing connectors 3 is positioned on a side of the electrical connector 2 proximal to the end surface of the base 1; and the other two fixing connectors 3 is provided on a straight line passing through the electrical connector 2 and parallel to the end surface of the base 1. Admittedly, in other embodiments, the fixing connector 3 may be arranged on a periphery taking the electrical connector 2 as a center, and a number thereof is not limited, which may be modified in accordance with actual situations.

In the present embodiment 4, each end surface of the base 1 is further provided a positioning part 6; the positioning part 6 is a groove concaved with respect to the end surface; and a direction of the groove is identical to an axial direction of the fixing connector 3 for playing a positioning role when splicing the splicing area 14 of the splicing piece to a lighting bar, improving the installation efficiency and reducing the possibility of incorrect installation. Admittedly, in other embodiments, a structure of the positioning part 6 may protrude from the end surface, or other structures that may be positioned with the lighting bar, which is not specifically limited in the present embodiment.

In the present embodiment 4, a fixing hole 15 is further provided in a central area 111 positioned among a plurality of connecting parts 11. The base 1 is connected or fixed to a designated position by connecting a fixing rod or other supporting members on the fixing hole 15 to achieve the fixation of the lighting bars by fixing the splicing pieces. Admittedly, the fixing hole 15 may also not be round in shape, which is not specifically limited in the present embodiment.

In the present embodiment 4, there are two surfaces on the base 1 perpendicular to the fixing connector 3, and a plurality of wiring grooves 5 is provided in any one of the two surfaces and connected between any two adjacent electrical connectors 2 with avoiding the fixing connector 3. There is a cover plate 4 mounted on a side of the wiring groove 5 and fixed to the base 1 by screws. Admittedly, the fixing manner between the cover plate 4 and the base 1 may further be other fixing manners besides screws, which is not specifically limited in the present embodiment.

In the present embodiment 4, the splicing area 14 is provided with a separate shielding plate 42 for separately shielding the electrical connector 2 and fixing the electrical connector 2. A fixing connection between the shielding plate 42 and the base 1 includes, but is not limited to, a screw fixation or an adhesive fixation. The shielding plate 42 and the cover plate 4 after mounted are aligned with or slightly below a surface of the base 1, so as to prevent affecting a splicing of splicable lighting apparatuses.

Referring to FIGS. 11-13, in the embodiment 1-4 of the present disclosure, each splicing area 14 on the base 1 includes a fixing insertion hole 141 in the same number as the fixing connector 3 and one electrical insertion slot 142. In order to increase the stability of the electrical connector 2, the electrical connector 2 is fixed in the electrical insertion slot 142, and the fixation manner may be, but is not limited to, such as insertion, welding, gluing or screwing. The fixing connector 3 is movably connected to the fixing insertion hole 141 and includes a driving end 32 and a fixing end 31; a restricting piece 33 is provided between the driving end 32 and the fixing end 31; and a driving groove 321 is provided on an end surface of the driving end 32, which facilitates manual operation to control the assembly or disassembly of the splicing piece and the lighting apparatuses. The shape of the driving groove 321 includes, but is not limited to, a lined, cross-shaped, double cross-shaped, plum-shaped, polygonal, or curved slot. The fixing end 31 is used to connect to the lighting apparatus, and the fixation manner controlled by the driving end 32 may be a threaded connection, a rotary snap fit or a magnetic connection. An annual groove 34 is provided on the fixing connector 3 between the driving end 32 and the fixing end 31. The restricting piece 33 is provided on the annual groove 34 and is a circular ring with an opening, which facilitates assembly of the restricting piece 33 to the annual groove 34, the annual groove 34 being proximal to the fixing end 31. When mounting the fixing connector 3, the fixing end 31 of the fixing connector 3 is inserted from an end of the fixing insertion hole 141 distal to the splicing area 14 to an end of the fixing insertion hole 141 proximal to the splicing area 14; the fixing end 31 is inserted and stops until the driving end 32 abutting the end of the fixing insertion hole 141 proximal to the splicing area 14; then the restricting piece 33 is snap-fitted to the annual groove 34 of the fixing connector 3, so that the fixing connector 3 may not be detached from the base 1 and may move relative to the base 1 in a direction of the fixing insertion hole 141 in a manner that includes, but is not limited to, being extending, retracting, sliding or rotating.

In embodiments 1-4 of the present disclosure, the wiring groove 5 may also be provided not on the base 1, but instead on the cover plate 4, specifically on a side of the cover plate 4 attached to the base 1, which also achieves concealment and protection of the wiring groove 5. Admittedly, it may also be provided with no cover plate 4, and the wiring groove 5 is provided at a center of the base 1, so that the wiring groove 5 is not exposed on any surface of the base 1, so as to achieve concealment and protection of the wiring groove 5. The cover plate 4 may also include, but is not limited to, a fixing perforation 41 and an electrical insertion hole, which are holes that are reserved to correspond to the fixing connectors 3 and the electrical connectors 2.

In the embodiment 3 of the present disclosure, a guiding groove 7 may also be provided on a side of the base 1 inserted with the fixing connector 3. The guiding groove 7 is provided along two edges in a length direction of the base 1 and protrudes from a surface of the base 1 and then bends toward a center of the base 1 to form a track-slot structure for fixing the base 1 to a position with a snap-fit slot or a snap-fit track.

The present disclosure further relates to a lighting apparatus, including at least two lighting bars and one splicing piece; and the lighting bar includes at least one mounting part for connecting to the splicing area 14 of the base 1 of any one of the embodiments 1-4. The mounting part may be concave with respect to the lighting bar, so that a top surface of the lighting bar is aligned with that of the splicing piece after mounted. Admittedly, the mounting part may not be concave and the splicing may be achieved by splicing a plurality of lighting bars. The splicing therebetween includes, but is not limited to, a snap-fitted or a magnetic connection between the splicing area 14 and the mounting part, which may achieve the stability and convenience of the splicing, so as to achieve a light distribution or a spotlight effect with a specific role.

In summary, a splicing piece and lighting apparatus provided by the present disclosure provides the following technical effects.

1. Improving aesthetics and safety by providing the electrical connector to conceal the previously exposed connectors to the splicing piece.

2. Improving the connecting stability between the splicing piece and the lighting apparatus and the electrical stability of the electrical connector by providing the fixing connector around the electrical connector.

3. Achieving the effect of the light distribution in different environments by providing various forms of connecting parts on the splicing piece.

4. Achieving no-shadow light distribution to objects or increasing the brightness of light to objects by splicing the splicing pieces with a plurality of lighting apparatuses.

The technical means disclosed in the solution of the present disclosure are not limited to those disclosed in the embodiments mentioned above but also include technical solutions consisting of any combination of the above technical features. It should be noted that for those skilled in the art, a plurality of improvements and modifications may be made without departing from the principles of the present disclosure, which should also be considered as the scope of protection of the present disclosure.

1. A splicing piece, comprising:
a base, the base provided with a central area and comprising at least two connecting parts, wherein the connecting part is centrosymmetrically provided around the central area and comprises at least one splicing area;
an electrical connector, the electrical connector provided on each splicing area;
a fixing connector, the fixing connector provided beside the electrical connector on the splicing area; and
at least one wiring groove, the wiring groove provided to avoid the fixing connector and used for being in communication with the adjacent electrical connectors on the splicing area.

2. The splicing piece according to claim 1, wherein at least two connecting parts of the base are non-coplanar; each two of the connecting parts are centrosymmetrically provided around the central area; and an included angle between the two connecting parts that are non-coplanar is 60°-150°.

3. The splicing piece according to claim 2, wherein the base comprises two connecting parts; the connecting part is provided with merely one splicing area; each splicing area is provided with one electrical connector and at least two fixing connectors; and the fixing connector is arranged on a periphery taking the electrical connector as a center.

4. The splicing piece according to claim 1, wherein each of the connecting parts of the base is coplanar with each other; each splicing area is provided with one electrical connector and at least two fixing connectors; and distances between each splicing area and the central area are identical.

5. The splicing piece according to claim 4, wherein the base comprises two connecting parts; both connecting parts are provided with merely one splicing area; the splicing area is provided with one electrical connector and at least two fixing connectors; a connecting line between one of the electrical connectors and the central area is collinear to a connecting line between the other of the electrical connectors and the central area; and both of the fixing connectors are positioned on a straight line between the electrical connector and the central area.

6. The splicing piece according to claim 4, wherein the base comprises a plurality of connecting parts; all of the connecting part is provided with merely one splicing area; the splicing area is provided with one electrical connector and three fixing connectors; and each two included angles are identical, wherein the included angle is between a line of any one of the electrical connectors to the central area and a line of the adjacent electrical connector to the central area.

7. The splicing piece according to claim 4, wherein the base comprises two connecting parts which are a first connecting part and a second connecting part respectively; both the first connecting part and the second connecting part are provided with merely one splicing area; the splicing area is provided with one electrical connector and three fixing connectors; and an included angle between a line of the first connecting part to the central area and a line of the second connecting part to the central area is 30°-150°.

8. The splicing piece according to claim 1, further comprising a cover plate; and the cover plate is provided on a surface where the wiring groove of the base is positioned, and used to cover the wiring groove.

9. The splicing piece according to claim 2, further comprising a cover plate; and the cover plate is provided on a surface where the wiring groove of the base is positioned, and used to cover the wiring groove.

10. The splicing piece according to claim 3, further comprising a cover plate; and the cover plate is provided on a surface where the wiring groove of the base is positioned, and used to cover the wiring groove.

11. The splicing piece according to claim 1, further comprising a positioning part; a surface of each connecting part distal to the central area is set as an end surface; and the positioning part is provided on the end surface of the connecting part positioned in each splicing area.

12. The splicing piece according to claim 2, further comprising a positioning part; a surface of each connecting part distal to the central area is set as an end surface; and the positioning part is provided on the end surface of the connecting part positioned in each splicing area.

13. The splicing piece according to claim 3, further comprising a positioning part; a surface of each connecting part distal to the central area is set as an end surface; and the positioning part is provided on the end surface of the connecting part positioned in each splicing area.

14. A lighting apparatus, comprising at least two lighting bars and one splicing piece, the splicing piece comprising:
a base, the base provided with a central area and comprising at least two connecting parts, wherein the connecting part is centrosymmetrically provided around the central area and comprises at least one splicing area;
an electrical connector, the electrical connector provided on each splicing area;
a fixing connector, the fixing connector provided beside the electrical connector on the splicing area;
at least one wiring groove, the wiring groove provided to avoid the fixing connector and used for being in communication with the adjacent electrical connectors on the splicing area; and
at least one mounting part for connecting to the splicing area of the base.

15. The lighting apparatus according to claim 14, wherein at least two connecting parts of the base are non-coplanar; each two of the connecting parts are centrosymmetrically provided around the central area; and an included angle between the two connecting parts that are non-coplanar is 60°-150°.

16. The lighting apparatus according to claim 15, wherein the base comprises two connecting parts; the connecting part is provided with merely one splicing area; each splicing area is provided with one electrical connector and at least two fixing connectors; and the fixing connector is arranged on a periphery taking the electrical connector as a center.

17. The lighting apparatus according to claim 14, wherein each of the connecting parts of the base is coplanar with each other; each splicing area is provided with one electrical connector and at least two fixing connectors; and distances between each splicing area and the central area are identical.

18. The lighting apparatus according to claim 17, wherein the base comprises two connecting parts; both connecting parts are provided with merely one splicing area; the splicing area is provided with one electrical connector and at least two fixing connectors; a connecting line between one of the electrical connectors and the central area is collinear to a connecting line between the other of the electrical connectors and the central area; and both of the fixing connectors are positioned on a straight line between the electrical connector and the central area.

19. The lighting apparatus according to claim 17, wherein the base comprises a plurality of connecting parts; all of the connecting part is provided with merely one splicing area; the splicing area is provided with one electrical connector and three fixing connectors; and each two included angles are identical, wherein the included angle is between a line of any one of the electrical connectors to the central area and a line of the adjacent electrical connector to the central area.

20. The lighting apparatus according to claim 17, wherein the base comprises two connecting parts which are a first connecting part and a second connecting part respectively; both the first connecting part and the second connecting part are provided with merely one splicing area; the splicing area is provided with one electrical connector and three fixing connectors; and an included angle between a line of the first connecting part to the central area and a line of the second connecting part to the central area is 30°-150°.
